(19) United States
(12) Patent Application Publication
(10) Pub. No.: US 2026/0180143 A1
(43) Pub. Date: Jun. 25, 2026

(54) Cid Filter and Secondary Battery, Battery Pack, Battery Module, and Vehicle Including the Same

(71) Applicant: LG Energy Solution, Ltd., Seoul (KR)

(72) Inventors: Jungmin Cho, Daejeon (KR); Jung Hoon Kim, Daejeon (KR); Serim Jeon, Daejeon (KR)

(73) Assignee: LG Energy Solution, Ltd., Seoul (KR)

(21) Appl. No.: 19/428,853

(22) Filed: Dec. 22, 2025

(30) Foreign Application Priority Data
Dec. 24, 2024 (KR) 10-2024-0194830

(51) Int. Cl. H01M 50/578; H01M 50/152; H01M 50/249; H01M 50/342; H01M 50/531; H01M 50/586

(52) U.S. Cl. CPC H01M 50/578; H01M 50/152; H01M 50/3425; H01M 50/531; H01M 50/586; H01M 50/249; H01M 2200/20

(57) ABSTRACT

A current interruptive device (CID) filter for a secondary battery includes: a central portion located at the center of the CID filter; a peripheral portion located at an edge of the CID filter; and an intermediate portion including at least one through-hole positioned along a circumference of the central portion and a CID bridge connecting the central portion and the peripheral portion. The through-hole is asymmetrically positioned with respect to any one line passing through a central point of the CID filter.

### CROSS-REFERENCE TO RELATED APPLICATIONS

This application is based on and claims priority from Korean Patent Application No. 10-2024-0194830 filed on Dec. 24, 2024, with the Korean Intellectual Property Office, the disclosure of which is incorporated by reference herein in its entirety.

### TECHNICAL FIELD

The present disclosure relates to a current interruptive device (CID) filter and a secondary battery including the same, a battery module and a battery pack including the secondary battery, and a vehicle including the battery pack.

### BACKGROUND

Unlike a primary battery that cannot be recharged, a secondary battery refers to a battery capable of being charged and discharged. Such secondary batteries are widely used in advanced electronic devices such as mobile phones, notebook computers, and camcorders.

The secondary battery may secure safety by undergoing a safety test in which one surface is pressed by a pressurizing machine to measure an internal short circuit.

According to the shape of a battery case, secondary batteries are classified into a cylindrical battery in which an electrode assembly is embedded in a cylindrical metal battery case, a prismatic battery in which an electrode assembly is embedded in a prismatic metal battery case, and a pouch-type battery in which an electrode assembly is embedded in a pouch-type battery case made of an aluminum laminate sheet.

Meanwhile, in some cases, the temperature or internal pressure of the secondary battery may rise due to an abnormal behavior of the secondary battery. In order to prevent or suppress the risks of fire or explosion that may occur in such cases, safety devices are provided in the secondary battery.

### SUMMARY

The present disclosure provides a current interruptive device (CID) filter capable of smoothly and rapidly discharging gas generated inside a secondary battery during operation such as overheating, short-circuiting, or fire, and a secondary battery, a battery module, and a battery pack including the same.

According to one embodiment of the present disclosure, a CID filter for a secondary battery includes: a central portion located at the center of the CID filter; a peripheral portion located at an edge of the CID filter; and an intermediate portion including at least one through-hole positioned along a circumference of the central portion and a CID bridge connecting the central portion and the peripheral portion, in which the through-hole is asymmetrically positioned with respect to any one line passing through a central point of the CID filter.

According to one embodiment of the present disclosure, a secondary battery includes: an electrode assembly including an electrode and a separator; a battery case configured to accommodate the electrode assembly and having an open top; a top cap coupled to an upper portion of the battery case; a safety vent provided on a lower portion of the top cap; and the CID filter provided below the safety vent and having at least a portion of an upper surface positioned at a lower surface of the safety vent.

A secondary battery including the CID filter according to an embodiment of the present disclosure, and a battery module and a battery pack including the same, may smoothly and rapidly discharge the gas generated inside the secondary battery to the outside by adjusting the size and position of a gas discharge hole of the CID filter, thereby preventing or suppressing an explosion of the secondary battery.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a plan view illustrating a CID filter according to an embodiment of the present disclosure.

FIG. 2 is a projection view of a cylindrical secondary battery illustrating a bonding position of an electrode tab according to an embodiment of the present disclosure.

FIG. 3 is a cross-sectional view illustrating a cylindrical secondary battery according to an embodiment of the present disclosure.

FIG. 4 is a perspective view illustrating a battery pack including a cylindrical secondary battery according to an embodiment of the present disclosure.

FIG. 5 is a perspective view illustrating a moving unit including a battery pack according to an embodiment of the present disclosure.

FIG. 6 is a graph illustrating a flow velocity of gas discharged through a through-hole of a CID filter over time in secondary batteries according to Example 1 and Comparative Example 1.

FIG. 7 is a photograph illustrating a gas discharge flow in which gas inside the secondary batteries according to Example 1 and Comparative Example 1 is discharged to the outside through a through-hole of a CID filter.

FIG. 8 is a photograph illustrating a pressure difference between a discharge hole of a top cap (hereinafter, an upper portion of a positive tab, \textcircled{1}) through which gas is discharged to the outside and a space between a positive tab and an electrode assembly (hereinafter, a lower portion of the positive tab, \textcircled{2}) in secondary batteries according to Example 1 and Comparative Example 1.

FIG. 9A is a perspective view illustrating a secondary battery according to Comparative Example 2, and FIG. 9B is a perspective view illustrating a secondary battery according to Example 2.

FIG. 10 is a graph illustrating internal pressure of secondary batteries according to Example 2 and Comparative Example 2 over time.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The detailed description of the present disclosure is provided to explain the present disclosure to those skilled in the art. Throughout the specification, when a part is referred to as “including” a component, or when a structure or shape is referred to as being “characterized by” a particular feature, it does not mean that other components are excluded or that other structures and shapes are eliminated, unless otherwise specified, but rather that other components, structures, and shapes may be included.

The present disclosure is susceptible to various modifications and various embodiments, and specific embodiments will be presented and described in detail in the detailed description. However, this is not intended to limit the scope of the present disclosure to the embodiments, and it should be understood that all modifications, equivalents, and substitutes included within the spirit and technical scope of the present disclosure are encompassed.

As used herein, the terms “about,” “approximately,” and “substantially” refer to a range of, or approximation to a numerical value or degree, taking into account inherent manufacturing and material tolerances (e.g., ±5%)

A safety device provided in a secondary battery may be a safety vent that is mainly mounted on a cylindrical secondary battery. For example, when internal pressure of the secondary battery increases, the safety vent moves upward and a portion of the safety vent is ruptured, thereby forming a path through which gas is discharged. Through this path, gas inside the secondary battery is discharged to the outside, thus preventing or suppressing the risk of explosion.

As another example, a current interruptive device (CID) filter, which is mainly mounted on a cylindrical secondary battery, may be mentioned. The CID filter is provided below the safety vent and attached thereto. When the above-described safety vent moves upward, the CID filter also moves upward together with the safety vent, and a portion of the CID filter is ruptured, thereby interrupting the flow of current.

However, when gas discharge through the CID filter is not smooth, a problem arises in that the secondary battery undergoes thermal runaway and explodes. The present disclosure provides a technology capable of smoothly and rapidly discharging gas generated inside the secondary battery to the outside by adjusting the size and position of a gas discharge hole of the CID filter, thereby preventing or suppressing an explosion of the secondary battery.

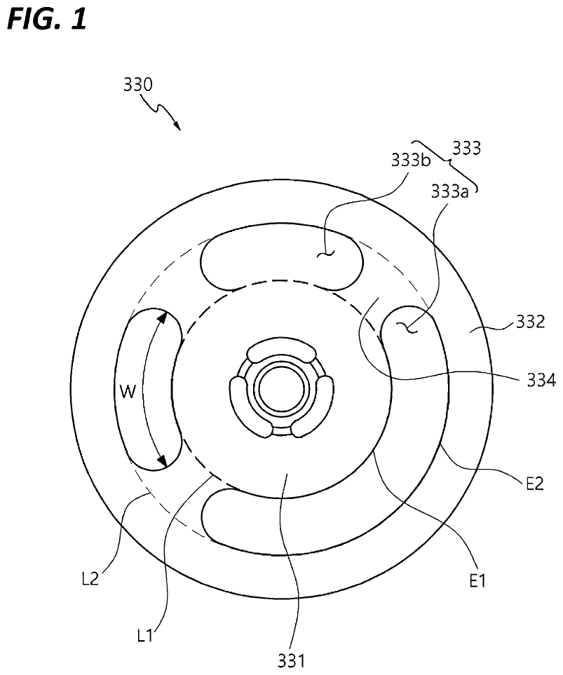

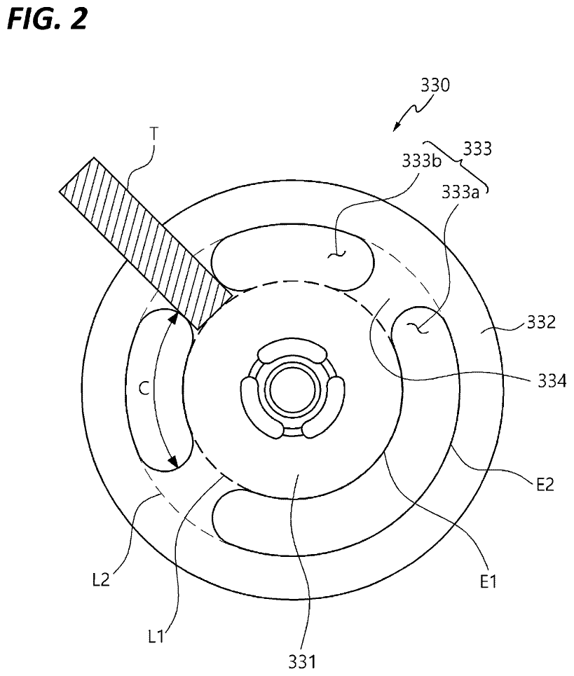

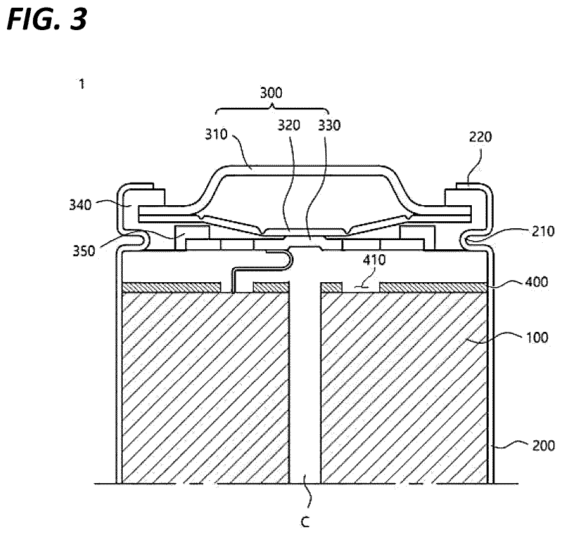

FIG. 1 is a plan view illustrating a CID filter 330 of a cylindrical secondary battery according to an embodiment of the present disclosure, FIG. 2 is a projection view of the cylindrical secondary battery illustrating a bonding position of an electrode tab T according to an embodiment of the present disclosure, and FIG. 3 is a cross-sectional view illustrating a cylindrical secondary battery 1 according to an embodiment of the present disclosure.

A cylindrical secondary battery 1 according to the present disclosure includes an electrode assembly 100, a battery case 200, and a cap assembly 300. The cap assembly 300 includes a top cap 310, a safety vent 320, and a CID filter 330.

The top cap 310 is located at an uppermost portion of the cap assembly 300 and may protrude in a direction opposite to a central direction or an inner direction of the battery case 200. The top cap 310 may serve as an electrode terminal of the secondary battery 1 such that the protruding portion is electrically connected to the outside. For example, the top cap 310 may serve as a positive electrode terminal of the secondary battery 1.

A sealing gasket 340 may be coupled at an edge of the top cap 310. The sealing gasket 340 may be positioned inside a crimping portion 220 of the battery case 200. The sealing gasket 340 may increase sealing force between the top cap 310 and the battery case 200.

The top cap 310 may include a protruding portion protruding upward, an edge portion that is in contact with and coupled to the sealing gasket 340, and a first connection portion connecting the protruding portion and the edge portion. The first connection portion may include at least one gas discharge hole.

The safety vent 320 is located below the top cap 310 and may be electrically connected to the top cap 310. At least a portion of the surface of the safety vent 320 facing the top cap 310 may be in contact with the top cap 310. The safety vent 320 may be in contact with the top cap 310 over a predetermined length from an end thereof, and a portion except for the contact length may be spaced apart from the top cap 310 by a predetermined distance. In addition, a portion of the safety vent 320 that is in contact with the top cap 310 may be coupled to the sealing gasket 340.

In a region where the safety vent 320 is in contact with the top cap 310, a distance between the safety vent 320 and the top cap 310 may increase toward a center of the safety vent 320.

The safety vent 320 may include a contact portion in contact with the top cap 310, a central portion located at a center of the safety vent 320 and in contact with the CID filter and recessed toward a direction in which the electrode assembly 100 is positioned, and a second connection portion connecting the contact portion and the central portion. The safety vent 320 may include a bent portion (or a notch) at a portion where the contact portion and the second connection portion are in contact and at a portion where the second connection portion and the central portion are in contact.

In one embodiment, an end portion of the safety vent 320 may be provided to be perpendicular to an axial direction of the battery case 200. The top cap 310 may also be provided to be perpendicular to the axial direction of the battery case 200, as in the safety vent 320. For example, the safety vent 320 and the top cap 310 may be positioned horizontally.

In another embodiment, an end portion of the safety vent 320 may be bent to surround an outer circumferential surface of the top cap 310.

The safety vent 320 may include a first rupture portion at portions where the contact portion and the second connection portion, and the second connection portion and the central portion are in contact. The first rupture portion may include at least one notch and may have a predetermined shape.

When heat generation caused by internal short circuit, overcharge, or overdischarge induces an electrolyte decomposition reaction and a thermal runaway phenomenon in the secondary battery 1, gas is generated or heat is produced inside the secondary battery 1, thereby increasing internal pressure. When internal pressure of the secondary battery 1 increases, the safety vent 320 receives a force toward the top cap 310, and the first rupture portion is ruptured, thereby discharging gas inside the secondary battery 1.

The first rupture portion may include both ends, and the both ends may be spaced apart from each other by a predetermined distance. A notch of the first rupture portion may be formed in a predetermined shape such that the both ends of the first rupture portion are connected to each other. For example, the first rupture portion may be formed in at least one shape of a curve or a straight line, such as a U shape or a V shape. A portion between the both ends is a non-rupture portion that is not ruptured by internal pressure of the secondary battery 1.

A notch of the first rupture portion may be provided on one of both surfaces of the safety vent 320. For example, the notch of the first rupture portion may be provided on the surface of the safety vent 320 opposite to the surface facing the electrode assembly 100.

The CID filter 330 is located below the safety vent 320, and at least a portion thereof may be connected to the safety vent 320.

The CID filter 330 may include a central portion 331 that is connected to the safety vent 320 at a central part and protrudes in a direction in which the safety vent 320 is positioned, a peripheral portion 332 excluding the central portion 331, and an intermediate portion including a CID bridge 334 connecting the central portion 331 and the peripheral portion 332 and a through-hole 333 that discharges gas generated inside the secondary battery 1 to the outside.

In this case, the intermediate portion may be defined as a region where the through-hole 333 is formed. For example, the through-hole 333 may include a first end E1 located in a central direction of the CID filter 330 (or in a direction in which the central portion 331 is positioned) and a second end E2 located in an edge direction of the CID filter 330 (or in a direction in which the peripheral portion 332 is positioned).

In one embodiment, when a single through-hole 333 is included in the intermediate portion, the intermediate portion may be defined by an extension line L1 obtained by extending the first end E1 in a clockwise or counterclockwise direction and an extension line L2 obtained by extending the second end E2 in a clockwise or counterclockwise direction.

In another embodiment, when a plurality of through-holes 333 is included in the intermediate portion, the central portion 331, the peripheral portion 332, and the intermediate portion may be defined by a line L1 connecting the first ends E1 of the plurality of through-holes 333 and a line L2 connecting the second ends E2 of the plurality of through-holes 333.

In this case, the ends of the through-hole 333 defining the intermediate portion may be based on a through-hole 333 having the largest length, and the length of the through-hole 333 refers to a distance between the first end E1 and the second end E2.

When the internal pressure of the secondary battery 1 increases and the safety vent 320 ruptures, the CID filter 330 is separated from the safety vent 320 and interrupts the current flow.

When the safety vent 320 is deformed in a direction in which the top cap 310 is positioned, the CID bridge 334 is broken, and the central portion 331 may be separated from the peripheral portion 332. For example, the central portion 331 is separated in the direction of the top cap 310 while being connected to the safety vent 320.

The through-hole 333 may include a main through-hole 333a and an auxiliary through-hole 333b, and one or more of the main through-hole 333a and the auxiliary through-hole 333b may be included. For example, a plurality of auxiliary through-holes 333b may be included with one main through-hole 333a at the central portion.

The main through-hole 333a and the auxiliary through-hole 333b may differ in at least one of the length and area. The length of the main through-hole 333a may be longer than a width of the auxiliary through-hole 333b, the area or width of the main through-hole 333a may be larger than an area or width of the auxiliary through-hole 333b, or both the length, and the area of the main through-hole 333a may be greater than the width and area of the auxiliary through-hole 333b.

The shape of the through-hole 333 is not particularly limited as long as the through-hole 333 discharges gas inside the secondary battery 1 to the outside. In one embodiment, a plurality of through-holes 333 may include at least one shape among a circular shape, a rectangular shape, and an arc shape, or may include at least one shape among a circular shape and an arc shape.

The length of the through-hole 333 refers to the length of an arc passing through a center of the through-hole 333. In other words, the length of the through-hole 333 refers to a straight or curved line passing through a center of the through-hole 333, that is, a length of a straight or curved line connecting the center of the through-hole 333 and two points on a circumference of the through-hole 333. In this case, the two points on the circumference of the through-hole 333 refer to two points located farthest apart from each other and in symmetrical positions.

The length of the main through-hole 333a may be about 30% to 70% based on a circumference of an intermediate portion connecting centers of the main through-hole 333a and the auxiliary through-hole 333b. For example, the length of the main through-hole 333a may be about 35% to 65% or about 40% to 60% based on the circumference connecting the centers of the main through-hole 333a and the auxiliary through-hole 333b.

In one embodiment, the area of the main through-hole 333a may be formed to be about 3/10 to 7/10 of a total area of the central portion. For example, the area of the main through-hole 333a may be formed to be about 7/20 to 13/20, or about ⅖ to ⅗ of the total area of the central portion.

By satisfying the above range of the length and area of the main through-hole 333a, the area through which high-pressure gas inside the secondary battery 1 is discharged to the outside is increased, thereby reducing discharge pressure and allowing high-pressure gas to be smoothly and rapidly discharged to the outside.

The CID bridge 334 is formed as a result of a plurality of through-holes 333 being spaced apart from each other, and the length or width of the CID bridge 334 may be adjusted according to the distance between the through-holes 333. The length or width of the CID bridge 334 refers to a distance between lines extended from a first end E1 and a second end E2 of two corresponding or symmetrical points of two adjacent through-holes 333.

The intermediate portion according to the present disclosure includes a plurality of auxiliary through-holes 333b and one main through-hole 333a, and the length of the CID bridge 334 located between the auxiliary through-holes 333b may be longer than a length of the CID bridge 334 located between the main through-hole 333a and the auxiliary through-hole 333b.

When a plurality of CID bridges 334 located between the auxiliary through-holes 333b is included in the intermediate portion, the lengths of the plurality of CID bridges 334 may all be the same or at least one of the plurality of CID bridges 334 may have a different length.

For example, the length of the CID bridge 334 facing the main through-hole 333a among the plurality of CID bridges 334 may be the longest.

One of the plurality of CID bridges 334 may be coupled to an electrode tab T described below. The length of the CID bridge 334 to which the electrode tab T is coupled may be equal to or greater than a width of the electrode tab T. The electrode tab T coupled to the CID bridge 334 may be a negative electrode tab or a positive electrode tab, and, for example, may be a positive electrode tab.

The electrode tab T may be coupled to the CID bridge 334 located between adjacent auxiliary through-holes 333b. In one embodiment, the electrode tab T may be coupled to the CID bridge 334 facing the main through-hole 333a.

For example, the electrode tab T may be coupled to the CID bridge 334 having the greatest length among the plurality of CID bridges 334. The electrode tab T may be coupled to the CID bridge 334 located farthest from the main through-hole 333a.

The coupling method between the electrode tab T and the CID bridge 334 is not particularly limited as long as electrical connection can be achieved. For example, the electrode tab T may be coupled to the CID bridge 334 by welding.

By coupling the electrode tab T to the CID bridge 334 located opposite to the main through-hole 333a, the electrode tab T does not block a part or the entire main through-hole 333a, thereby facilitating the discharge of the gas inside the secondary battery 1 to the outside through the main through-hole 333a.

Since the length of the CID bridge 334 is equal to or greater than the length of the electrode tab T, the electrode tab T does not block a part or the entire auxiliary through-hole 333b. Accordingly, the path through which the gas inside the secondary battery 1 is discharged to the outside is not reduced, and the gas that is not discharged through the main through-hole 333a may be rapidly discharged to the outside through the auxiliary through-hole 333b, thereby preventing or suppressing explosion of the secondary battery 1.

The cap assembly 300 according to the present disclosure may further include a CID gasket 350. The CID gasket 350 surrounds an edge of the CID filter 330 and may electrically isolate the peripheral portion 332 and the intermediate portion of the CID filter 330 from the safety vent 320.

The secondary battery 1 according to another embodiment of the present disclosure may further include an insulator 400 between the electrode assembly 100 and the CID filter 330.

The insulator 400 may be disposed to cover an upper surface of the electrode assembly 100. By covering the upper surface of the electrode assembly 100, the insulator 400 may prevent or suppress direct contact between the electrode assembly 100 and the cap assembly 300.

The insulator 400 may include a tab hole 410 through which an electrode tab protruding upward from the electrode assembly 100 is drawn out. The electrode tab may be drawn upward through the tab hole 410 and coupled to the CID bridge 334.

The tab hole 410 may also discharge gas generated inside the secondary battery 1 to reduce internal pressure of the secondary battery 1.

The insulator 400 may include a plurality of tab holes 410, and the center of any one of the plurality of tab holes 410 may be located at a position corresponding to the center of the through-hole 333 of the CID filter. For example, the center of any one of the plurality of tab holes 410 may be located at a position corresponding to the center of the main through-hole 333a of the CID filter.

The insulator 400 may be made of an insulating polymer resin, for example, a polymer resin such as polyethylene, polypropylene, polyimide, or polybutylene terephthalate.

The secondary battery 1 may further include a current collector plate (not illustrated) between the insulator 400 and the electrode assembly 100.

The case 200 may have one open surface and may include a space accommodating the electrode assembly 100 and an electrolyte.

The electrolyte may be a nonaqueous organic solvent. The nonaqueous organic solvent may include, for example, a cyclic carbonate-based solvent, a linear carbonate-based solvent, or a mixed solvent thereof. For example, the nonaqueous organic solvent may include at least one compound selected from ethylene carbonate, dimethyl carbonate, and ethyl methyl carbonate.

In one embodiment, the case 200 may have a cylindrical structure with an internal space. The case 200 may accommodate an electrode assembly 100 including an electrode and a separator, and an electrolyte in the internal space. The case 200 may have a structure in which one side is open (hereinafter, referred to as an opening), and the other side is sealed. Here, one side and the other side of the case 200 refer to the upper and lower ends positioned along a gravity direction or a central axis of the case 200, and one surface and the other surface refer to the upper and lower cross sections positioned along the central axis of the case 200.

In one embodiment, the case 200 may be made of a lightweight conductive metal material such as aluminum or an aluminum alloy.

In one embodiment, the case 200 may include a beading portion 210 and a crimping portion 220 for fixing the cap assembly 300. For example, at the opening of the case 200, the crimping portion 220 and the beading portion 210 may be sequentially positioned in a lower direction of the case 200.

The beading portion 210 may be formed such that a side surface of the case 200 is folded toward a center direction of the case 200, and may be located between an upper surface of the electrode assembly 100 and the opening, or between the upper surface of the electrode assembly 100 and the crimping portion 220. The cap assembly 300 may be positioned on one surface of the beading portion 210.

Here, the side surface of the case 200 refers to the surface connecting one side and the other side.

The electrode assembly 100 according to one embodiment is a power-generating element capable of charge and discharge, including a positive electrode, a negative electrode, and one or two separators.

For example, the electrode assembly 100 may include a jelly-roll structure in which a first separator, a negative electrode, a second separator, and a positive electrode are sequentially stacked and wound around the mandrel. Alternatively, the electrode assembly 100 may include a jelly-roll structure in which a negative electrode, a first separator, a positive electrode, or a jelly-roll structure formed by supplying the layers to the mandrel, and winding thereon.

In one embodiment, the electrode assembly 100 may include a hollow portion C located on a winding axis of the electrode assembly 100. The hollow portion C may be formed by winding the positive electrode, the negative electrode, and the separator around the mandrel, and then removing the mandrel. The hollow portion C may remain empty, or the center pin may be accommodated therein.

The center pin may prevent or suppress deformation or collapse of a core portion due to expansion and contraction of the electrode assembly 100. The core portion may refer to the hollow portion C, or a region including the hollow portion C and a part of the wound negative electrode, first separator, positive electrode, and second separator adjacent to the hollow portion C.

For example, the core portion may refer to a region within two turns from one end in a longitudinal direction of an electrode positioned at an innermost layer of the electrode assembly 100. In addition, “one turn” may refer to a length required for a 360° winding of an electrode or a separator included in the electrode assembly 100 from a reference point, and the length may be determined according to an outer diameter of the mandrel used for winding, a thickness of the electrode or separator, and the number of windings of the electrode or separator positioned on the inner side. For example, one turn of the negative electrode may refer to a length required to wind the negative electrode by 360° from one longitudinal end of the negative electrode in a direction in which a jelly-roll type electrode assembly is wound.

The positive electrode may include a positive electrode active material portion and a positive electrode uncoated portion. For example, the positive electrode may have a positive electrode active material coated on at least one surface of a positive electrode current collector, where a region coated with the positive electrode active material is the positive electrode active material portion and a region not coated with the positive electrode active material is the positive electrode uncoated portion.

The positive electrode uncoated portion is a portion of the positive electrode current collector exposed to the outside, and the positive electrode uncoated portion and the positive electrode current collector may be made of the same material. For example, the positive electrode current collector and the positive electrode uncoated portion may be a metal foil having excellent electrical conductivity, such as an aluminum (Al) foil.

The positive electrode uncoated portion is a region where a first electrode tab is located since the positive electrode active material is not coated, so that the positive electrode may be electrically connected to the cap assembly 300 that is described later. For example, the first electrode tab may be joined to the positive electrode uncoated portion by welding.

The positive electrode active material may include a lithium cobalt oxide having a high operating voltage and excellent capacity characteristics, a lithium nickel oxide having a high reversible capacity and suitable for high-capacity batteries, a lithium nickel cobalt oxide in which a part of nickel is substituted with cobalt, a lithium nickel cobalt metal oxide in which a part of nickel is substituted with manganese, cobalt, or aluminum, a lithium manganese oxide having excellent thermal stability and low cost, or a lithium iron phosphate having excellent stability.

The negative electrode may include a negative electrode active material portion and a negative electrode uncoated portion. For example, the negative electrode has a negative electrode active material coated on one or both surfaces of a negative electrode current collector. The negative electrode active material portion is formed by coating or applying the negative electrode active material, and the negative electrode uncoated portion is a region where the negative electrode current collector is exposed without coating or applying the negative electrode active material. For example, the negative electrode current collector and the negative electrode uncoated portion may be a metal foil having excellent electrical conductivity, that is, the negative electrode current collector and the negative electrode uncoated portion may include a copper (Cu) foil or a nickel (Ni) foil.

The negative electrode uncoated portion is a region where a second electrode tab is located since the negative electrode active material is not applied, so that the negative electrode may be electrically connected to the case 200 that is described later. For example, the second electrode tab and the negative electrode uncoated portion may be joined by welding the second electrode tab to the negative electrode uncoated portion.

The negative electrode may further include a third electrode tab. In one embodiment, negative electrode uncoated portions may be located on both sides of the negative electrode active material portion. In other words, the negative electrode may be arranged such that, from a winding start end to a winding end direction of the negative electrode current collector, a negative electrode uncoated portion, a negative electrode active material portion, and another negative electrode uncoated portion are sequentially positioned.

In one embodiment, electrode tabs may be located at each of the negative electrode uncoated portions positioned at a winding start end and a winding end of the negative electrode. For example, a second electrode tab may be joined to the negative electrode uncoated portion positioned at the winding start end, and a third electrode tab may be joined to the negative electrode uncoated portion positioned at the winding end.

The negative electrode active material may be, for example, a carbon material such as crystalline carbon, amorphous carbon, a carbon composite, or carbon fiber, or may be lithium metal or a lithium alloy. The negative electrode active material may further include, for high-capacity design, a non-graphitic material such as SiO₂ (silica) or SiC (silicon carbide).

The first electrode tab and the second electrode tab transfer electrons collected in the current collector to an external circuit and may protrude in opposite directions with respect to the electrode assembly of the jelly-roll structure.

The separator prevents an internal short circuit that may occur due to contact between the positive electrode and the negative electrode, and may include a porous material that allows smooth movement of ions between the electrodes.

In one embodiment, the separator may include a substrate layer made of a porous material. The substrate layer may include one selected from polyethylene (PE), polystyrene (PS), polypropylene (PP), and a copolymer of polyethylene (PE) and polypropylene (PP).

In another embodiment, the separator may include a safety reinforced separator (SRS). For example, the separator may include a substrate layer made of a porous material and a coating layer formed by coating a mixed slurry containing inorganic particles and a binder polymer on the substrate layer. The coating layer includes ceramic particles and has a uniform pore structure formed by interstitial volumes between the ceramic particles, which serve as active components, in addition to a pore structure inherently included in the separator substrate itself.

The coating layer may include ceramic particles including at least one selected from alumina, silica, TiO₂, SiC, and MgAl₂O₄. By including such a coating layer, safety of the electrode assembly may be enhanced. In one embodiment, the coating layer may further include a lithium salt.

According to one embodiment of the present disclosure, a battery pack 3 includes any one of the above-described secondary batteries 1.

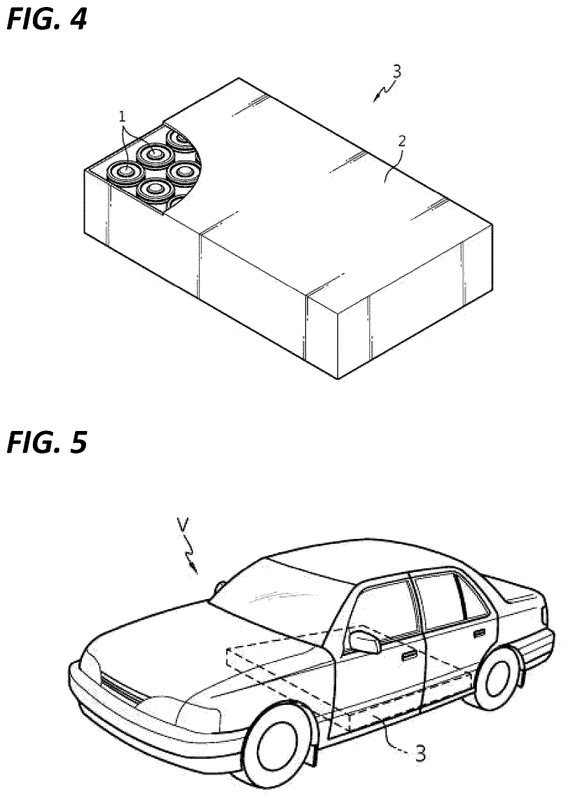

Referring to FIG. 4 in connection with the above embodiment, the battery pack 3 including the secondary battery 1 in a pack housing 2 is illustrated.

The battery pack 3 according to the above embodiment has high output and high capacity.

According to one embodiment of the present disclosure, a moving unit includes the above-described battery pack 3.

Referring to FIG. 5 in connection with the above embodiment, a moving unit V including the battery pack 3 is illustrated. In one embodiment, the moving unit V may be an electric vehicle.

Since the moving unit according to the above embodiment uses the battery pack 3 having high output and high capacity, it is excellent in terms of stability and safety.

### Manufacture of Electrode Assembly

As a positive electrode current collector, an Al foil having a thickness of 15 μm and a widthwise length of 63.9 mm was prepared. A positive electrode active material slurry containing an NMCA (Ni—Mn—Co—Al) composite having a Ni content of 92% or more as a positive electrode active material and CNT as a conductive material was applied and dried on the positive electrode current collector to form a positive electrode active material layer, thereby manufacturing a positive electrode having a thickness of 154 μm.

The positive electrode includes a positive electrode uncoated portion where the positive electrode active material slurry is not applied and a positive electrode active material portion where the positive electrode active material slurry is applied, and the portions are positioned in the order of the positive electrode uncoated portion, the positive electrode active material portion, and the positive electrode uncoated portion. Electrode tabs are attached to the positive electrode uncoated portions.

As a negative electrode current collector, a Cu foil having a thickness of 8 μm and a widthwise length of 65.1 mm was prepared. A negative electrode active material slurry containing 50 parts by weight of artificial graphite and 50 parts by weight of natural graphite as a negative electrode active material was applied and dried on the negative electrode current collector to form a negative electrode active material layer, thereby manufacturing a negative electrode having a thickness of 187 μm.

The negative electrode includes a negative electrode uncoated portion where the negative electrode active material slurry is not applied and a negative electrode active material portion where the negative electrode active material slurry is applied, and the portions are positioned in the order of the negative electrode active material portion, the negative electrode uncoated portion, and the negative electrode active material portion. A negative electrode tab is attached to the negative electrode uncoated portion.

As a first separator and a second separator, two sheet-type separators were prepared, each including a polyethylene substrate layer having a coating layer formed on one surface thereof, the coating layer containing Al₂O₃ as an inorganic component, a PVdF-based binder as a binder component, and a lithium salt.

A jelly-roll type electrode assembly was manufactured by sequentially stacking and then winding the first separator, the negative electrode, the second separator, and the positive electrode.

### Manufacturing of Secondary Battery

The jelly-roll type electrode assembly was inserted into a cylindrical battery case. An electrolyte was injected, which was prepared by mixing ethylene carbonate (EC), dimethyl carbonate (DMC), and ethyl methyl carbonate (EMC) in a weight ratio of 4:9:3 and dissolving LiPF₆ at a concentration of 15 wt %. The cylindrical battery case was then sealed with a cap assembly to manufacture a secondary battery.

### Example 1

In the secondary battery according to Example 1, a positive electrode tab (in-tab) located at a winding start portion among the positive electrode uncoated portions extends from a bridge of the CID filter of the cap assembly toward the center portion and is bonded thereto.

### Example 2

The secondary battery according to Example 2 further includes an insulator in the secondary battery of Example 1. The insulator is positioned between the electrode assembly and the CID filter and includes two tab holes. The center of one of the two tab holes is located at a position corresponding to a center of the main through-hole of the CID filter, and another tab hole is where the positive electrode tab is drawn out.

### Comparative Example 1

In the secondary battery according to Comparative Example 1, a positive electrode tab (in-tab) located at a winding start portion among the positive electrode uncoated portions extends across one of the through-holes of the CID filter and is bonded to the center portion.

### Comparative Example 2

The secondary battery according to Comparative Example 2 further includes an insulator in the secondary battery of Example 1. The insulator is positioned between the electrode assembly and the CID filter and includes one tab hole.

### Measurement of Internal Pressure and Discharge Gas Flow Velocity of Secondary Battery

The temperature of the atmosphere where the secondary battery was placed was 23° C., and the pressure was 1 bar. The internal temperature of the secondary battery was 750° C., and the pressure was 10 bar.

The internal pressure was measured at the core portion of the electrode assembly. The discharge gas flow velocity for Examples was measured at a gas discharge hole of the top cap located opposite to the positive electrode tab, while the discharge gas velocity for Comparative Examples was measured at a gas discharge hole of the top cap located at a position corresponding to the position of the positive electrode tab.

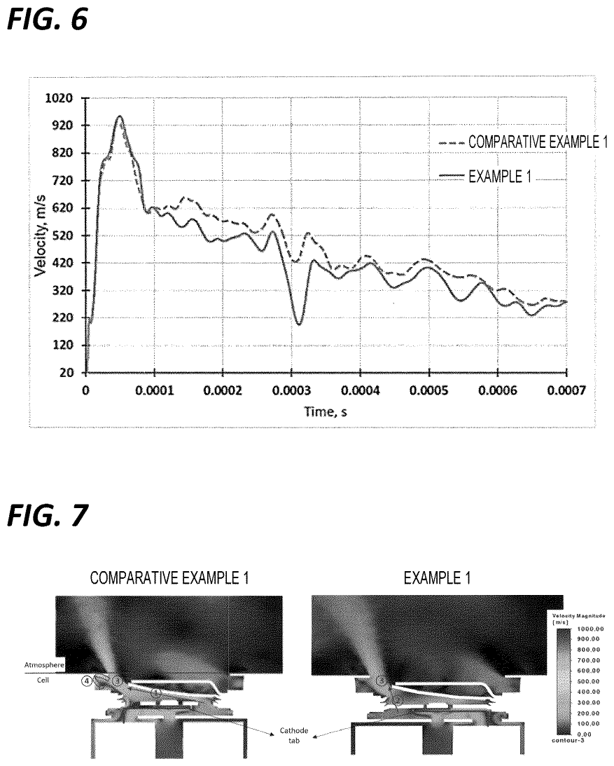

FIG. 6 is a graph illustrating a flow velocity of the gas discharged through a through-hole of a CID filter over time in secondary batteries according to Example 1 and Comparative Example 1.

In Example 1 and Comparative Example 1, assuming the gas movement between cells of the same volume (e.g., the same gas amount) and the external atmosphere, the cross-sectional area of the passage between the cell and the external atmosphere in Example 1 is larger. Therefore, it can be confirmed that the flow velocity of the gas at the through-hole in Example 1 is up to about 200 m/s slower than that in Comparative Example 1, based on the time immediately after 0.0003 seconds have elapsed.

In Comparative Example 1, the flow velocity at the gas discharge hole of the top cap is slower than in the example, so it takes longer for the internal pressure of the secondary battery to decrease. Accordingly, Comparative Example 1 has a problem in that the pressure discharge is not smooth, and thus an explosion is more likely to occur.

FIG. 7 is a photograph illustrating a gas discharge flow in which gas inside the secondary battery according to Example 1 and Comparative Example 1 is discharged to the outside through a through-hole of a CID filter.

Referring to FIG. 7, in Comparative Example 1, gas is not smoothly discharged through the through-hole of the CID filter located at the portion where the positive electrode tab is positioned, and thus is discharged through the through-hole of the CID filter located opposite to the positive electrode tab. It can be confirmed that the gas flows (\textcircled{1}) through the space between the safety vent and the CID filter and is discharged through the gas discharge hole (\textcircled{3}) of the top cap positioned at a location corresponding to the portion where the positive electrode tab is located.

In Example 1, it can be confirmed that, since the through-hole of the CID filter located opposite to the positive electrode tab has the largest length, gas is discharged through the through-hole located opposite to the positive electrode tab. It can also be confirmed that the gas is discharged in the shortest path through the gas discharge hole (\textcircled{3}) of the top cap positioned at the same location as the through-hole (\textcircled{2}) having the largest length.

Accordingly, in Comparative Example 1, the length of the through-hole of the CID filter is reduced by the positive electrode tab, and the flow path of the gas inside the cap assembly becomes longer. As a result, the flow velocity at the gas discharge hole of the top cap increases, and the gas discharge becomes less smooth.

In contrast, in Example 1, since the length of the through-hole of the CID filter is not reduced, and the through-hole of the CID filter is formed asymmetrically, the flow velocity at the gas discharge hole of the top cap does not increase, and the gas discharge becomes smoother.

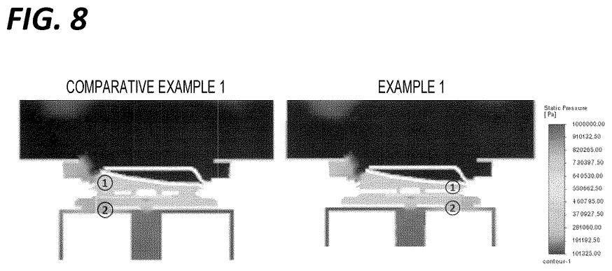

FIG. 8 is a photograph illustrating a pressure difference between a discharge hole of a top cap (hereinafter, an upper portion of a positive tab, \textcircled{1}) through which gas is discharged to the outside and a space between a positive tab and an electrode assembly (hereinafter, a lower portion of the positive tab, \textcircled{2}) in secondary batteries according to Example 1 and Comparative Example 1.

In Comparative Example 1, a pressure difference of 3 bar or more is generated between the upper portion and the lower portion of the positive electrode tab. As a result, the positive electrode tab and the cap assembly may be deformed or damaged, and the damaged components may block the gas discharge path.

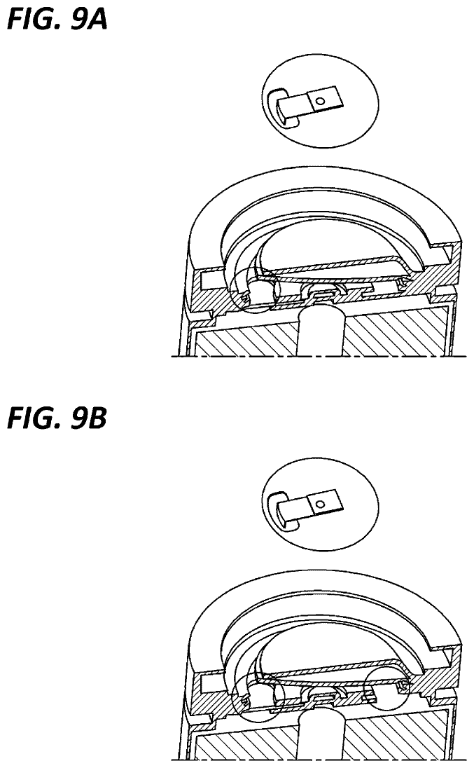

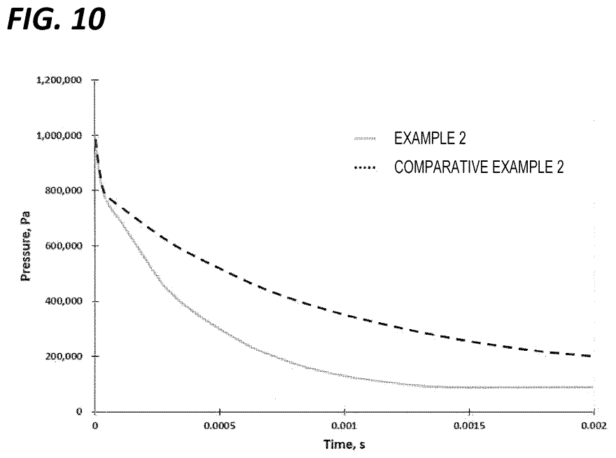

FIG. 9A is a perspective view illustrating the secondary battery according to Comparative Example 2, FIG. 9B is a perspective view illustrating the secondary battery according to Example 2, and FIG. 10 is a graph illustrating internal pressure of the secondary batteries according to Example 2 and Comparative Example 2 over time.

Referring to FIG. 9A, it is shown that, in Comparative Example 2, the center of one of the two tab holes is located at a position corresponding to the center of the main through-hole of the CID filter. Referring to FIG. 9B, it is shown that, in Example 2, an additional hole is provided to improve gas discharge.

Referring to FIG. 10, it can be confirmed that, in Comparative Example 2, the gas discharge is not smooth, so the pressure is higher than in Example 2. It can also be confirmed that, in Example 2, the range of pressure decrease over time is wider than that in Comparative Example 2. Therefore, when the tab hole of the insulator is blocked by the positive electrode tab, it acts as a factor that hinders the discharge of gas from inside the secondary battery to the outside.

While the embodiments of the present disclosure have been described above, it will be understood by those skilled in the art that various modifications and changes can be made within the scope and spirit of the present disclosure as defined by the claims below.

What is claimed is:

1. A current interruptive device (CID) filter for a secondary battery, comprising:
a central portion located at a center of the CID filter;
a peripheral portion located at an edge of the CID filter; and
an intermediate portion including at least one through-hole positioned along a circumference of the central portion, and a CID bridge connecting the central portion and the peripheral portion,
wherein the through-hole is asymmetrically positioned with respect to any one line passing through a central point of the CID filter.

2. The CID filter for a secondary battery according to claim 1, wherein the through-hole includes one main through-hole and at least one auxiliary through-hole, and
the main through-hole and the auxiliary through-hole differ in at least one of length and area.

3. The CID filter for a secondary battery according to claim 2, wherein a length of the main through-hole is longer than an arc of the auxiliary through-hole,
an area of the main through-hole is larger than an area of the auxiliary through-hole,
or both the length and area of the main through-hole are greater than the arc and area of the auxiliary through-hole.

4. The CID filter for a secondary battery according to claim 2, wherein the through-hole includes a plurality of the auxiliary through-holes, and the plurality of auxiliary through-holes are positioned adjacent to each other, and
a length of the CID bridges located between the auxiliary through-holes is longer than a length of the CID bridges located between the main through-hole and the auxiliary through-hole.

5. The CID filter for a secondary battery according to claim 2, wherein a length of the main through-hole is about 30% to 70% based on a circumference of the intermediate portion passing through a center of the main through-hole.

6. A secondary battery comprising:
an electrode assembly including an electrode and a separator;
a battery case configured to accommodate the electrode assembly and having an open top;
a top cap coupled to an upper portion of the battery case;
a safety vent provided on a lower portion of the top cap; and
the CID filter for a secondary battery according to claim 1, provided below the safety vent and having at least a portion of an upper surface positioned at a lower surface of the safety vent.

7. The secondary battery according to claim 6, wherein the electrode assembly includes an electrode tab protruding toward the CID filter, and
the electrode tab is bonded to the CID bridge.

8. The secondary battery according to claim 7, wherein the through-hole includes one main through-hole and one or more auxiliary through-holes, and
the electrode tab is bonded to the CID bridges located between the main through-hole and the auxiliary through-holes, or
the electrode tab is bonded to the CID bridges located between adjacent ones of the plurality of auxiliary through-holes.

9. The secondary battery according to claim 8, wherein a length of the CID bridges located between the main through-hole and the auxiliary through-holes or a length of the CID bridges located between adjacent ones of the plurality of auxiliary through-holes is equal to a length of the electrode tab or is greater than a width of the electrode tab.

10. The secondary battery according to claim 6, further comprising:
an insulator disposed between the electrode assembly and the CID filter,
wherein the insulator includes a plurality of tab holes.

11. The secondary battery according to claim 10, wherein a center of any one of the plurality of tab holes is positioned at a location corresponding to a center of the through-hole of the CID filter.

12. A battery module comprising the secondary battery according to claim 6.

13. A battery pack comprising the secondary battery according to claim 6.

14. A battery pack comprising the battery module according to claim 12.

15. An electric vehicle comprising the battery pack according to claim 14.
